(19) United States
(12) Patent Application Publication
(10) Pub. No.: US 2022/0004298 A1
(43) Pub. Date: Jan. 6, 2022

(54) PREDICTION CONTROL METHOD, INPUT SYSTEM AND COMPUTER READABLE RECORDING MEDIUM

(71) Applicant: Wistron Corp., New Taipei City (TW)

(72) Inventors: Lu PENG, New Taipei City (TW); Qiuxia QIAN, New Taipei City (TW)

(21) Appl. No.: 17/017,866

(22) Filed: Sep. 11, 2020

(30) Foreign Application Priority Data
Jul. 6, 2020 (CN) 202010640461.0

(51) Int. Cl. G06F 3/0486; G06F 3/0481; G06F 3/0488; G06F 3/041

(52) U.S. Cl. CPC G06F 3/0486; G06F 3/0418; G06F 3/04883; G06F 3/04817

(57) ABSTRACT

A prediction control method is suitable for a display device to display an input moving signal. The prediction control method includes matching a plurality of coordinates corresponding to the input moving signal with a plurality of specific coordinates of the display device and predicting the input moving signal, so that the display device displays the predicted coordinates of the input moving signal.

### CROSS REFERENCE TO RELATED APPLICATIONS

This application claims priority of China Patent Application No. 202010640461.0, filed on Jul. 6, 2020 the entirety of which is incorporated by reference herein.

### BACKGROUND OF THE INVENTION

### Field of the Invention

The present disclosure relates to a prediction method and, in particular, to a prediction control method, input system and computer readable recording medium suitable for a display device.

### Description of the Related Art

Notebook computers are popular today. Input devices include mouse devices, touch input devices, and styluses. In recent years, the size of the display devices that can be manufactured has increased, and multiple large display devices can also be spliced into a display device wall. These large display devices are usually placed in banks, hospitals or shopping malls, and may have touch functionality. In addition to displaying information, some display devices allow users to click on the information that they want to read. Generally speaking, these large monitors are usually installed on a wall, and they cannot be controlled by ordinary users via an external computer connected to the large monitor.

However, when users want to use input devices to achieve large-scale movement on large display devices, the functions of existing input devices are limited, whether these input devices constitute fingers, eye tracking input technology, a mouse, a stylus or another input device. It's difficult to move quickly and accurately across a large area on a large display device. For example, it is difficult to accurately and quickly drag files display in the lower right corner of large display devices to a specific position in the upper left corner using a finger, eye tracking input technology, a mouse, a stylus, or another conventional input device.

Therefore, how to quickly and accurately move an indicator signal on a large display device has become one of the problems to be solved in this field.

### BRIEF SUMMARY OF THE INVENTION

In accordance with one feature of some embodiments, the present disclosure provides a prediction control method suitable for a display device to display an input moving signal. The prediction control method including: matching a plurality of coordinates corresponding to the input moving signal with a plurality of specific coordinates of the display device; and predicting the input moving signal, so that the display device displays the predicted coordinates of the input moving signal.

In accordance with one feature of some embodiments, the present disclosure provides an input system suitable for a display device to display an input moving signal. The input system includes a pointer positioning device and calculating and predicting device. The pointer positioning device is configured to match a plurality of coordinates corresponding to the input moving signal with a plurality of specific coordinates of the display device. The calculating and predicting device is configured to predict the input moving signal, so that the display device displays the predicted coordinates of the input moving signal.

### BRIEF DESCRIPTION OF THE DRAWINGS

In order to describe the manner in which the above-recited and other advantages and features of the disclosure can be obtained, a more particular description of the principles briefly described above will be rendered by reference to specific examples thereof which are illustrated in the appended drawings. Understanding that these drawings depict only example aspects of the disclosure and are not therefore to be considered to be limiting of its scope, the principles herein are described and explained with additional specificity and detail through the use of the accompanying drawings in which:

FIG. 1 is a block diagram of an input system in accordance with one embodiment of the present disclosure.

FIG. 2 is a flowchart of a prediction control method in accordance with one embodiment of the present disclosure.

FIG. 3 is a schematic diagram of a display device center in accordance with one embodiment of the present disclosure.

FIG. 4 is a schematic diagram of the coordinates of the initial position P and the coordinates of the display device center in accordance with one embodiment of the present disclosure.

FIG. 5 is a schematic diagram illustrating a time series prediction method of RNN LSTM in accordance with one embodiment of the present disclosure.

FIG. 6 is a schematic diagram of an enlarged view of block A in FIG. 4 in accordance with one embodiment of the present disclosure.

FIG. 7 is a schematic diagram of an optical touch application scenario in accordance with one embodiment of the present disclosure.

FIGS. 8A-8C are schematic diagrams of an optical touch application scenario in accordance with one embodiment of the present disclosure.

FIG. 9 is a flowchart of a prediction control method 900 in accordance with one embodiment of the present disclosure.

### DETAILED DESCRIPTION OF THE INVENTION

The following description is of the best-contemplated mode of carrying out the application. This description is made for the purpose of illustrating the general principles of the application and should not be taken in a limiting sense. The scope of the application is best determined by reference to the appended claims.

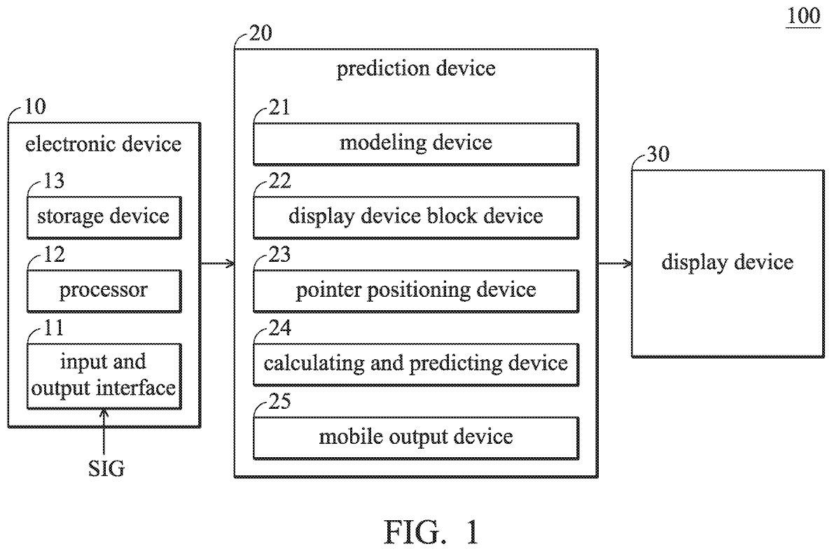

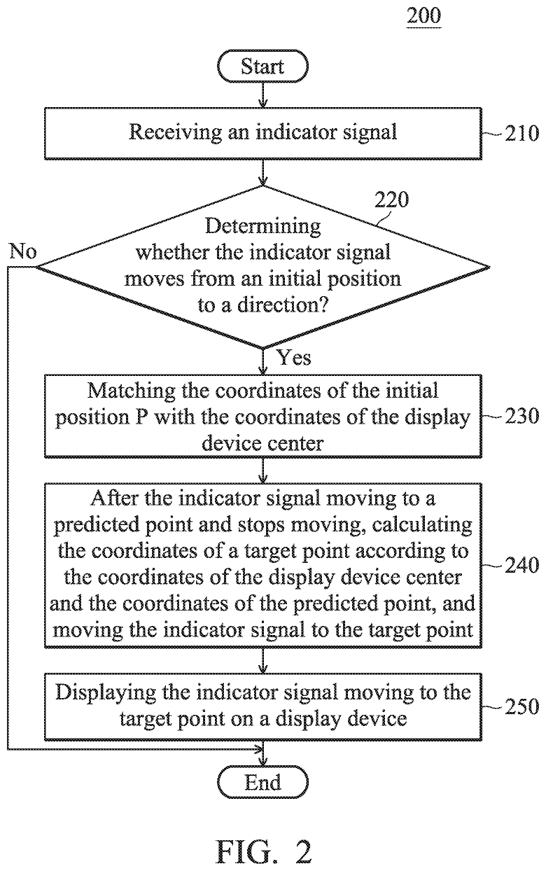

Please refer to FIGS. 1 and 2, FIG. 1 is a block diagram of an input system 100 in accordance with one embodiment of the present disclosure. FIG. 2 is a flowchart of a prediction control method 200 in accordance with one embodiment of the present disclosure.

In one embodiment, the input system 100 is suitable for a display device 30 to display an input moving signal (for example, indicators signal SIG). The input system includes a pointer positioning device 23 and a calculating and predicting device 24. The input positioning device 23 is used to predict the input moving signal (for example, the indicator signal SIG), so that the display device 30 display the coordinates predicted according to the input moving signal.

The following further uses FIGS. 1 and 2 to illustrate the detailed technical features.

In one embodiment, as shown in FIG. 1, the input system 100 includes an electronic device 10 and a prediction device 20. In one embodiment, the electronic device 10 is, for example, a host, a server, a tablet, a laptop, a mobile phone, or other devices that can receive signals for calculation and storing. In one embodiment, the electronic device 10 includes an input and output interface 11, a processor 12 and a storage device 13. In one embodiment, the input and output interface 11 is, for example, a mouse signal receiver, a touch panel, or other interfaces that can be used to receive signals. In one embodiment, the storage device 13 can be implemented as a read-only memory, flash memory, floppy disk, hard disk, optical disk, flash drive, tape, a database accessible by the network, or those familiar with the art can easily think about storage media with the same function. The storage device 13 can be used to store information about the indicator signal SIG at each time point, such as coordinates information.

In one embodiment, the prediction device 20 includes a modeling device 21, a display device block device 22, a pointer positioning device 23, a calculating and predicting device 24, and a mobile output device 25.

In one embodiment, the modeling device 21, the display device block device 22, the pointer positioning device 23, the calculating and predicting device 24, and the mobile output device 25 may be implemented by integrated circuits such as micro controller, microprocessor, digital signal processor, application specific integrated circuit (ASIC) or a logic circuit.

In one embodiment, the calculations or functions performed by the modeling device 21, the display device block device 22, the pointer positioning device 23, the calculating and predicting device 24, and the mobile output device 25 can be implemented by software or firmware. The processor 12 is used to perform these operations.

In one embodiment, when the amount of calculation is small, the processor 12 can execute the calculations performed by the modeling device 21, the display device block device 22, the pointer positioning device 23, the calculating and predicting device 24, and the mobile output device 25.

In one embodiment, the indicator signal SIG is, for example, a mouse cursor signal, a finger touch signal, a stylus touch signal, and the physical position (for example, the position where the mouse actually slides on the desktop) is usually displayed on the display device 30 corresponds to display position (for example, the position of the mouse cursor on the display device 30). The method for the physical location to correspond to the display device location is a known technology, so it will not be repeated here.

In one embodiment, the display device 30 in the input system 100 may be a large-scale display device. In one embodiment, the input system 100 can include multiple display devices 30. In one embodiment, the large display device is, for example, a spliced display device wall, a large interactive touch display device (for example, 86 inches touch display device), an interactive touch electronic display device signboard, etc.

The prediction control method 200 is described below. The prediction control method 200 can be implemented by the input system 100. In one embodiment, the prediction control method 200 can be implemented by firmware, program code, or software, and the program code or software stored in a computer-readable recording medium. And, the processor in the computer readable recording medium can execute these firmware, code or software.

In one embodiment, pressing the display device 30 with a finger or a stylus for more than three seconds will activate the indicator signal prediction function. In one embodiment, when the processor 12 receives the signal of pressing the left button and the right button of the mouse twice in the same time, the processor 12 turns on the indicator signal prediction function. In one embodiment, the prediction control method 200 can be implemented in one execution file. After the input system 100 installing this executable file, there will be an option for out of range movement in the settings of the computer. When the option of the out of range movement (i.e., over-range movement function) is selected, the processor 12 starts the prediction control method 200.

In one embodiment, when the option of the over-range movement function is clicked, it can be set in advance to project the indicator signal SIG to different display device screens using software or hardware drive methods such as automatic or system notification.

In step 210, the input and output interface 11 is used to receive an indicator signal SIG.

For example, the input and output interface 11 is used to receive the mouse cursor signal and regard the mouse cursor signal as the indicator signal SIG.

In step 220, the modeling device 21 or the processor 12 is used to determine whether the indicator signal SIG moves from an initial position to a direction.

In one embodiment, this direction can be any direction. In other words, as long as the modeling device 21 detects the movement of the indicator signal SIG (for example, the displacement distance of the indicator signal SIG is greater than the Euclidean distance threshold), then step 230 is performed.

In one embodiment, the Euclidean distance is a commonly used distance definition, which is the true distance between two points in an m-dimensional space (where the symbol m can be a value greater than 2). The Euclidean distance in two-dimensional and three-dimensional space is the distance between two points. In other words, Euclidean distance can be used to measure the distance between two points in space.

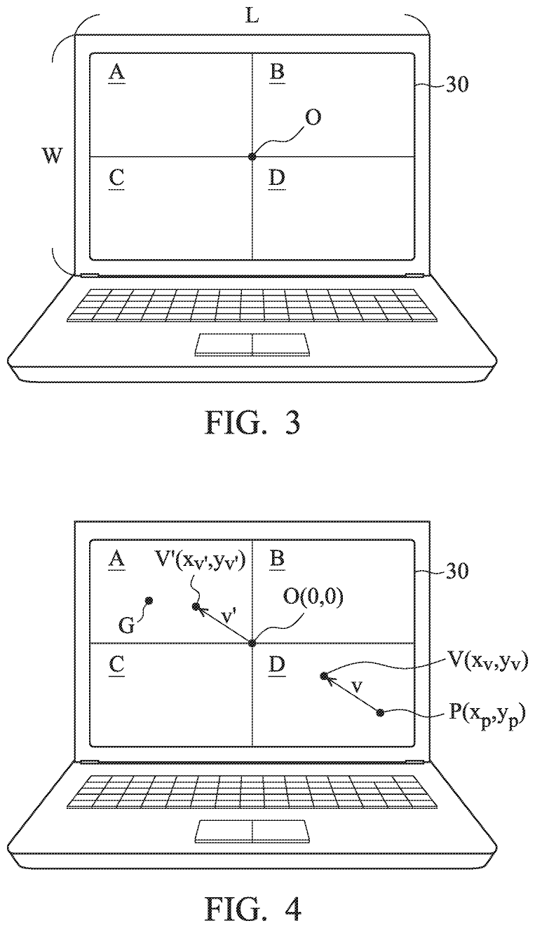

In one embodiment, the display device block device 22 is used to define a display device center O. FIG. 3 is a schematic diagram of a display device center O in accordance with one embodiment of the present disclosure. It can be seen from FIG. 3 that the display device block device 22 is used to separate the center line of length L and the center line of width W of the display device 30. The intersection of the two center lines is regarded as the display device center O, and the coordinates of the display device center O are defined as O(0,0). Those with ordinary knowledge in the field should understand that the display device center can be defined based on actual practice. The intersection point of the straight line (not necessarily the midline of the length L) and the horizontal line (not necessarily the midline of the width W) is not necessarily at the center of the display device 30. But the intersection of the straight line and the horizontal line is regarded as the origin of the screen O(0,0).

In one embodiment, the display device block device 22 divides the display device 30 into four blocks A-D by the center line of length L and the center line of width W of the display device 30.

In one embodiment, if the modeling device 21 does not detect the movement of the indicator signal SIG, the process is ended or step 210 is entered again.

In step 230, when the modeling device 21 or the processor 12 determines that the indicator signal SIG moves in the direction, the pointer positioning device 23 or the processor 12 matches the coordinates of the initial position P with the coordinates of the display device center O(0,0).

In one embodiment, the index positioning device 21 or the processor 12 defines the coordinates P(xₚ,yₚ) of the initial position P as the origin O(0,0), so that the pointer positioning device 23 will set the coordinates P(xₚ,yₚ) to overlap with the coordinates O(0,0) of the display device center O. At this time, the coordinates P(xₚ,yₚ) of the initial position P is regarded as P(0,0).

In one embodiment, FIG. 4 is a schematic diagram of the coordinates P(xₚ,yₚ) of the initial position P and the coordinates O(0,0) of the display device center O in accordance with one embodiment of the present disclosure. In FIG. 4, the coordinates of the initial position P of the pointer positioning device 23 on the display device 30 is P(xₚ,yₚ). In this step, the coordinates P(xₚ,yₚ) of the initial position P are regarded as the coordinates O(0,0) of the display device center O, and the coordinates of the initial position P are overlapped with the coordinates O(0,0) of the display device center O together. In other words, the movement of the indicator signal SIG in the block D corresponds to the movement of the coordinates O(0,0) of the display device center O. For example, if the indicator signal SIG moves from the coordinates P(xₚ,yₚ) of the initial position P to the direction v, it is considered that the indicator signal SIG moves from the coordinates O(0,0) of the display device center O to the direction v′, and the direction v is the same as the vector of the direction v′.

In this way, when the display device 30 is very large, the indicator signal SIG in the block D can be moved to the block A by over-range movement. In other words, the movement of the indicator signal SIG in block D is equivalent to the movement of the indicator signal SIG in block A.

In step 240, after the indicator signal SIG moves to a predicted point V′ and stops moving, the calculating and predicting device 24 or the processor 12 according to the coordinates O(0,0) of the display device center O and the coordinates V′(x_{v′},y_{v′}) of the predicted point V′ calculates the coordinates of a target point G, and the indicator signal SIG moves to the target point G.

In one embodiment, the indicator signal SIG moves to the target point G according to the coordinates of the target point G.

In one embodiment, the indicator signal SIG moves to the stop point V of the area D, and its coordinates are V(xᵥ,yᵥ), which is equivalent to that the indicator signal SIG moves to the prediction point V′ of the area A, and its coordinates are V′(xᵥ′,yᵥ′). In this way, the movement of the indicator signal SIG in the area D can be moved as over-range movement of the indicator signal SIG to the block A through the prediction control method 200, and the same movement occurs in the area D (the direction v and the vector of the direction v′ are the same).

Therefore, when the display device 30 is very large, the indicator signal SIG can be moved from the area D to the area A without moving the mouse, finger or other input devices greatly.

In one embodiment, the calculating and predicting device 24 or the processor 12 inputs the coordinates V′(x_{v′},y_{v′}) of the predicted point V′ into a Recurrent Neural Network-Long Short-Term Memory (RNN LSTM) time series prediction method, and coordinates of a target point G is output using the time series prediction method of the RNN LSTM.

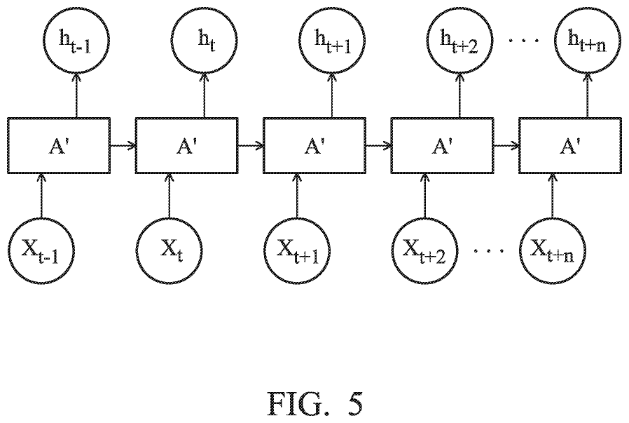

FIG. 5 is a schematic diagram illustrating a time series prediction method 500 of RNN LSTM in accordance with one embodiment of the present disclosure. For example, the user double-clicks the left and right buttons of the mouse twice to start the prediction control method 200. When the indicator signal SIG of the mouse moves slightly, if the indicator signal SIG moves to the point Xₜ, the calculating and predicting device 24 can obtain the coordinates Xₜ (xₜ, yₜ) of the indicator signal SIG at this time, and the coordinates Xₜ₋₁ (xₜ₋₁, yₜ₋₁) of the previous sequence history (the pause position of the previous time point or the last clicked position) is substituted into the RNN LSTM A′, and the RNN LSTM A′ outputs hₜ₋₁. This represents the coordinates position at time t−1, and then substitutes hₜ₋₁ into the next RNN LSTM A′ to predict the predicted output coordinates position hₜ of the current coordinates Xₜ, coordinates position hₜ represents the coordinates position at time t, and then repeat these steps. For example, if the previous output hₜ and coordinates Xₜ₊₁ (xₜ₊₁, yₜ₊₁) are substituted into the RNN LSTM A′, the RNN LSTM A′ outputs hₜ₊₁, which represents the predicted coordinates position at time t+1. If the previous output hₜ₊₁ and coordinates Xₜ₊₂ (xₜ₊₂,yₜ₊₂) are substituted into the RNN LSTM A′, RNN LSTM A′ outputs hₜ₊₂, which represents the predicted coordinates position at time t+2. By analogy, the previous output hₜ₊ₙ₋₁ and coordinates Xₜ₊ₙ(xₜ₊ₙ,yₜ₊ₙ) are substituted into the RNN LSTM A′, and RNN LSTM A′ outputs hₜ₊ₙ, this represents the predicted coordinates position at time t+n. In one embodiment, when the predicted coordinates position is the same as the actual control indicator position or the Euclidean distance is less than a convergence threshold, it is regarded as the completion of training the model of the RNN LSTM.

In one embodiment, the time series prediction formula is X(t)=X(t−1)+Er(t). This formula can be one of the operations in RNN LSTM A′, where Er(t) represents the noise at current time point t. In one embodiment, the size of the display device 30, the indicator signal SIG moves to different destinations, the variables of the indicator signal SIG (for example, the initial speed, the angle of the movement indicator signal SIG are different), the prediction control method 200 combines the habit of the user's movement indicator signal SIG is to add variables to a deep learning model (such as RNN LSTM A′) to train the model to predict the user's next target point.

It can be seen that when the indicator signal SIG has a targeted movement trend, the calculating and predicting device 24 applies time series prediction method 500 of the RNN LSTM to calculate and collect the coordinates of the indicator signal SIG, builds a model for the indicator signal SIG to obtain potential features, and combines with time series algorithms to establish predictions for the movement of the indicator signal SIG. For example, the coordinates of the target point G in FIG. 4 are predicted. The time series prediction method of RNN LSTM is a known algorithm, so it will not be repeated here.

In one embodiment, the target point G is the position where the calculating and predicting device 24 predicts that the user will move the indicator signal SIG to the next step or eventually.

In step 250, the mobile output device 25 is used to display the indicator signal SIG moving to the target point G on a display device 30.

In one embodiment, the position of the target point G will be more accurate as the amount of data calculated using the time series of the RNN LSTM increases, and the collected data for each correction of the target point G′ can be obtained from the calculation of the change of the target area R′.

In one embodiment, the calculating and predicting device 24 or the processor 12 calculates the Euclidean distance between the coordinates of the target point G and the coordinates of the corrected target point G′. The calculating and predicting device 24 or the processor 12 regards the Euclidean distance as a target area radius. When the target area radius is less than a minimum radius threshold (for example, the Euclidean distance is 0.1 unit), the calculating and predicting device 24 or the processor 12 outputs the coordinates of the corrected target point G′.

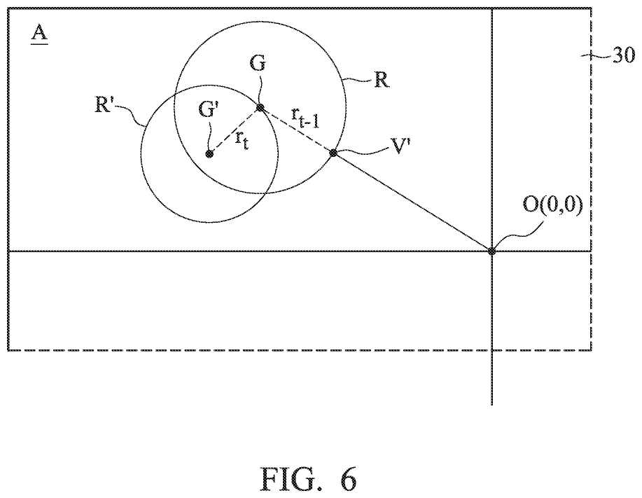

In one embodiment, FIG. 6 is a schematic diagram of an enlarged view of block A in FIG. 4 in accordance with one embodiment of the present disclosure. When time series prediction method 500 of the RNN LSTM is applied for the first time to estimate the coordinates of the target point G, the Euclidean distance can be calculated according to the coordinates of the target point G and the coordinates O(0,0) of the display device center O. As shown in FIG. 6, the target area radius from the target point G to the display device center O is rₜ₋₁=1/2|GO|ₜ₋₁, where |GO| represents the calculation of Euclidean distance. Before applying the time series prediction method 500 of RNN LSTM next time to estimate the next target point, the user can modify the current target point G to the corrected target point G′. The goal is to take the minimum Euclidean distance between the target point G and the corrected target point G′. When the Euclidean distance is equal to zero, it means that the prediction is completely accurate, and the target point G and the corrected target point G′ are the same point. The target area radius between the target point G and the corrected target point G′ at time t is rₜ=min|GG′|ₜ₋₁, where |GG′| represents the calculation of Euclidean distance.

The target area R and target point G will become more accurate as the amount data of time series input to the RNN LSTM increases, and the target area R will become smaller and smaller. The Euclidean distance between the target point G and the corrected target point G′ will also become smaller and smaller, and the correction area R′ will also become smaller and smaller, which means that the predicted target point G is more and more accurate. When the Euclidean distance between the target point G and the corrected target point G′ is less than a minimum radius threshold, for example, the target point G overlaps with the corrected target point G′, it means that the time series of the RNN LSTM has been trained very accurate, and the user does not need to correct the position of the target point G (no need to calculate the target point G and correct the target area radius of the target point G′), and the target point G can be directly displayed on the display device 30.

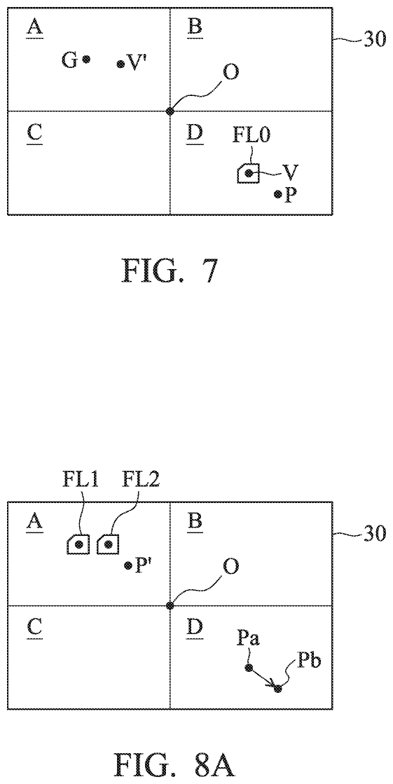

In one embodiment, FIG. 7 is a schematic diagram of an optical touch application scenario in accordance with one embodiment of the present disclosure. When the display device 30 is a touch display device, the stylus or finger can long-press the file FL0 to generate the indicator signal SIG. In other words, when the calculating and predicting device 24 or the processor 12 receives the indicator signal generated by long-pressing an icon (for example, the icon represents a file FL0 or an application), and the long-pressing time is greater than the time threshold (for example, 3 seconds), the calculating and predicting device 24 or the processor 12 activates the over-range movement function. The calculating and predicting device 24 or the processor 12 triggers the indicator signal SIG to move the file FL0 located in the block D from the initial position P to the stop point V. When the stylus or finger leaves the display device 30, the over-range movement function automatically moves the file FL0 to the predicted point V′ of the block A corresponding to the block D, and then the file FL0 automatically moves to the target point G.

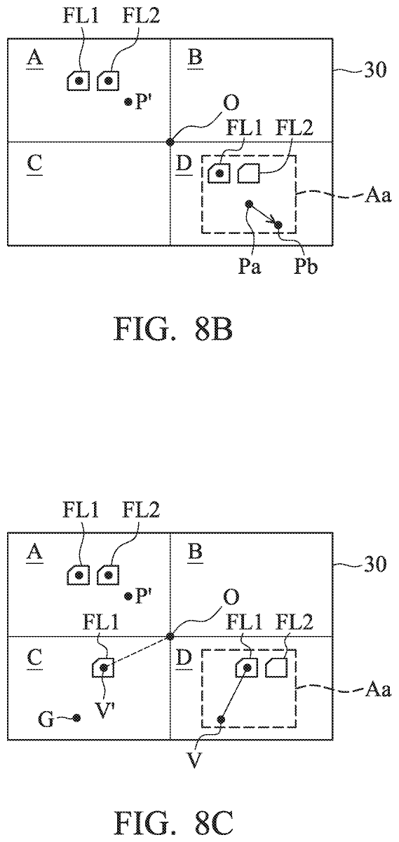

In one embodiment, FIGS. 8A to 8C are schematic diagrams of an optical touch application scenario in accordance with one embodiment of the present disclosure. When the display device 30 is a large-scale touch display device, for example, the display device 30 is a large-scale display device or a display device wall formed by splicing multiple large-scale display devices, placed in a bank, a hospital, a shopping mall or other spaces, and can be a touch-sensitive display device providing an interface to display information and interact with users. In this case, because the display device 30 is too large, the stylus or finger cannot click to block A, and the stylus or finger can press the position Pa for three seconds to generate the indicator signal SIG. And, the calculating and predicting device 24 or the processor 12 activates the over-range movement function, and the indicator signal SIG generated by the stylus or finger moves a short distance from the position Pa to the position Pb (as shown in FIG. 8A), and the stylus or finger is in the position Pb stays and presses for three seconds, the processor 12 triggers the display device 30 to display the small display device area Aa in the area D (as shown in FIG. 8B). The small display device block Aa is used to display the icons in block A (for example, the icons represent files or applications). The stylus or finger can click on the file FL1 or the application FL2 in the block A by clicking the file FL1 or the application FL2 in the small display device block Aa in the block D. In this way, even if the stylus or finger cannot click on the block A, the file FL1 or the application FL2 of the block A can be clicked in the block D using this method.

In one embodiment, as shown in FIG. 8C, when a small display device block Aa appears, a stylus (touch devices can be used in this situation) or a finger can generate the indicator signal SIG for clicking the file FL1 or application FL2 in small display device block Aa, so as to click the file FL1 or application FL2 in block A. Take the file FL1 in the small display device block Aa as an example, the indicator signal SIG clicks on the file FL1 in the small display device block Aa and drags the file FL1 to the stop point V. At the same time, the processor 12 triggers the block C of the display device 30 to correspond to the dragging direction of the file FL1 in the small display device block Aa, and displays that the file FL1 is dragged in the same direction from the display device center O to the prediction point V′. And, the calculating and predicting device 24 then automatically moves the file FL1 to the target point G.

In one embodiment, the prediction control method 200 can be applied to the operation of a purposeful indicator signal. For example, the prediction control method 200 can predict the target area where the controller will operate in a virtual reality, and the indicator signal moves quickly to the target area in the virtual space.

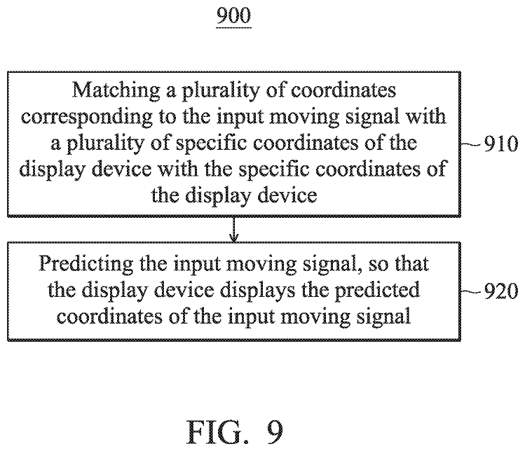

FIG. 9 is a flowchart of a prediction control method 900 in accordance with one embodiment of the present disclosure. In one embodiment, the prediction control method is suitable for a display device 30. The display device 30 displays an input moving signal (for example, an indicator signal SIG). The prediction control method includes matching a plurality of coordinates corresponding to the input moving signal with a plurality of specific coordinates of the display device 30 (for example, the indicator signal SIG) with the specific coordinates of the display device 30 (step 910), and predicting the input moving signal, so that the display device 30 displays the predicted coordinates of the input moving signal (such as step 920). In one embodiment, the prediction control method can be implemented by a computer-readable recording medium.

The prediction control method, input system, and computer-readable recording medium shown in the present invention can be used when the display device is large, such as a large display device in a square, a large wall optical touch panel, a display device screen of a virtual reality system, and a display device walls, etc., users can use non-continuous moving indicator signals to control other areas through a part block of the large display device, such as the less accessible block. By predicting the indicator signal, the indicator signal can also be moved to the target point more quickly. This saves the user's time to move the indicator signal, and improves the accuracy of manipulating the indicator signal on the large display device.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such a feature may be combined with one or more other features of the other implementations as may be desired and advantageous for any given or particular application.

1. A prediction control method, suitable for a display device to display an input moving signal, comprising:
matching a plurality of coordinates corresponding to the input moving signal with a plurality of specific coordinates of the display device; and
predicting the input moving signal, so that the display device displays a plurality of predicted coordinates of the input moving signal.

2. The prediction control method of claim 1, further comprising:
inputting the predicted coordinates into a time series prediction method of a Recurrent Neural Network-Long Short-Term Memory (RNN LSTM) using a processor, and outputting a plurality of target coordinates using the time series prediction method of the RNN LSTM.

3. The prediction control method of claim 1, further comprising:
defining the coordinates corresponding to the input moving signal as an origin and regarding the origin as an initial position using a processor, so that a pointer positioning device defines the coordinates corresponding to the input moving signal as the specific coordinates of the display device; wherein the specific coordinates of the display device are regarded as a center coordinates of the display device.

4. The prediction control method of claim 1, wherein the step of predicting the input moving signal further comprises:
calculating a Euclidean distance between a plurality of coordinates of a target point and a plurality of coordinates of a corrected target point, and regarding the Euclidean distance as a target area radius; and
in response to the target area radius is less than a minimum radius threshold, outputting the coordinates of the corrected target point.

5. The prediction control method of claim 1, wherein the step of predicting the input moving signal further comprises:
receiving an indicator signal generated by long-pressing a file using a processor;
wherein in response to duration of the long-pressing is greater than a time threshold, the processor enables an over-range movement function; and
wherein the processor triggers the indicator signal to move the file located in a first block from the initial position to a stop point; and
wherein in response to touch leaving a touch display device, the processor enables the over-range movement function to automatically move the file to a predicted point in a second block corresponding to the first block, and then to automatically move the file to a target point; wherein the indicator signal represents the input moving signal.

6. The prediction control method of claim 1, wherein the step of predicting the input moving signal further comprises:
receiving an indicator signal generated by long-pressing a file using a processor;
wherein in response to duration of the long-pressing is greater than the time threshold, the processor enables a touch display device to display a small display device block in a first block, and the small display device block is used to display an icon in a second block; and
using a touch device to click on the icon in the second block from the small display device block in the first block.

7. The prediction control method of claim 6, further comprising:
using the indicator signal to click the file in the small display device block and drag the file to a stop point;
wherein the processor triggers a third block of the display device to correspond to the dragging direction of the file in the small display device block, to display that the file is dragged in the same direction from the center of the display device to the predicted point, and then the processor automatically moves the file to the target point.

8. An input system, suitable for a display device to display an input moving signal, comprising:
a pointer positioning device, configured to match a plurality of coordinates corresponding to the input moving signal with a plurality of specific coordinates of the display device; and
a calculating and predicting device, configured to predict the input moving signal, so that the display device displays the predicted coordinates of the input moving signal.

9. The input system of claim 8, wherein the calculating and predicting device inputs the predicted coordinates into a time series prediction method of a Recurrent Neural Network-Long Short-Term Memory (RNN LSTM), and a plurality of target coordinates is output using the time series prediction method of the RNN LSTM.

10. The input system of claim 8, wherein the coordinates corresponding to the input moving signal is defined as an origin and the origin is regarded as an initial position, so that a pointer positioning device defines the coordinates corresponding to the input moving signal as the specific coordinates of the display device; wherein the specific coordinates of the display device are regarded as the center coordinates of the display device.

11. The input system of claim 8, wherein the calculating and predicting device calculates the Euclidean distance between the coordinates of a target point and a plurality of coordinates of a corrected target point, and regards the Euclidean distance as a target area radius; in response to the target area radius is less than a minimum radius threshold, the calculating and predicting device outputs the coordinates of the corrected target point.

12. The input system of claim 8, wherein in response to the display device is a touch display device, and the calculating and predicting device receives an indicator signal generated by long-pressing a file and in response to the duration of the long-pressing is greater than the time threshold, the calculating and predicting device enables an over-range movement function, and the indicator signal moves the file located in a first block from the initial position to a stop point; in response to touch leaving the touch display device, the over-range movement function automatically moves the file to a predicted point in a second block corresponding to the first block, and then automatically moves the file to a target point; wherein the indicator signal represents the input moving signal.

13. The input system of claim 8, wherein in response to the display device is a touch display device and an indicator signal is generated by long-pressing a file using a touch device, and the duration of the long-pressing is greater than the time threshold, the processor enables the touch display device to display a small display device block in a first block, and the small display device block is used to display an icon in a second block; the touch device clicks on the icon in the second block from the small display device block in the first block.

14. The input system of claim 13, wherein the touch device clicks the file in the small display device block and drags the file to a stop point; wherein a processor triggers a third block of the display device to correspond to the dragging direction of the file in the small display device block, to display that the file is dragged in the same direction from the center of the display device to the predicted point, and then the processor automatically moves the file to the target point.

15. A computer-readable recording medium for executing a prediction control method, the prediction control method comprising:
matching a plurality of coordinates corresponding to the input moving signal with a plurality of specific coordinates of the display device; and
predicting the input moving signal, so that the display device displays the predicted coordinates of the input moving signal.
